(19) United States
(12) Patent Application Publication
(10) Pub. No.: US 2012/0066518 A1
(43) Pub. Date: Mar. 15, 2012

(54) CANISTER-BASED STORAGE SYSTEM SECURITY

(75) Inventors: Steven H. McCown, Rigby, ID (US); Stephen S. Selkirk, Westminster, CO (US); Charles A. Milligan, Golden, CO (US); James P. Hughes, Herndon, VA (US); Jacques Debiez, Cugnaux (FR)

(73) Assignee: STORAGE TECHNOLOGY CORPORATION, LOUISVILLE, CO (US)

(21) Appl. No.: 13/196,781

(22) Filed: Aug. 2, 2011

Related U.S. Application Data
(63) Continuation of application No. 10/934,186, filed on Sep. 3, 2004, now abandoned.

(51) Int. Cl. G06F 12/14

(52) U.S. Cl. 713/193

(57) ABSTRACT

Security is provided for a data set stored in a data storage canister. The data set has a data size when received for storage within the canister. At least one data security operation is performed on the received data set to generate secure data having a secure data size that may be different than the set data size. The secure data is stored on at least one data storage device within the canister. Any information about the secure data size is kept from the data producer sending the data set for storage.

### BACKGROUND OF THE INVENTION

1. Field of the Invention

The present invention relates to controlling access to data storage, particularly canister-based storage systems including a plurality of storage elements.

2. Background Art

Increasing demands for data storage create the need for flexible storage solutions. One solution is to use highly flexible data storage canisters. Each canister includes a plurality of storage devices, such as disk drives, optical drives, solid-state memory, and the like. Each canister also includes at least one controller which provides interface functions such as protocol conversion, data formatting, RAID formatting, storage device control, and the like. One such canister-based storage system is disclosed in commonly assigned U.S. patent application Ser. No. 10/791,205, filed Mar. 2, 2004 and titled “Canister-Based Storage System,” which is hereby incorporated by reference in its entirety.

The storage canister in a canister-based system provides a wide variety of storage system options. Canisters may be inserted or removed, permitting storage archiving, rapid data transfer, disaster recovery, simple technology upgrading, and the like. Moreover, the same basic canister can be used in systems having vastly different complexity and operating characteristics. For example, a high-end system may have the capability of accessing multiple storage devices in multiple modules simultaneously for high data rate operation. Intermediate systems may include racks of canisters of which only one or a few are ever accessed at the same time. A low-end system may include a docking station accepting only one canister for access by an attached personal computer or work station.

The great flexibility offered by a canister-based storage system introduces security issues not typically encountered in traditional storage systems. For example, the ability to swap canisters into and out of a system requires a heightened amount of data security. Moreover, this security may have to extend to individual storage devices within a canister as well as to files or records held on one or more storage devices.

What is needed is a data security technique suited to the highly flexible nature of a canister-based storage system. Such a data security system should be readily implemented within a data storage canister and should hide security details from systems accessing the data storage canister.

### SUMMARY OF THE INVENTION

The present invention implements canister security with a data storage controller performing security operations on received data generating secured data of greater size. Systems which access the canister are unaware of the additional supporting data created within the canister.

Accordingly, a data storage system is provided. The data storage system includes at least one data producer generating data for storage, a key server providing a data security key and at least one data storage canister. Each data storage canister includes a plurality of data storage devices and a controller. The controller receives data for storage within the canister having a set size, for example a size of N words. A data security key is received from the key server. The controller preforms at least one data security operation on the received data with the received data security key to generate secure data having a size of N+K words. The controller then stores the N+K words on at least one of the data storage devices. Throughout this process, the data producer is unaware that the N words of data are stored as N+K words within the canister.

In an embodiment of the present invention, the controller receives a data access request from a requesting data consumer to access N words of data. The controller retrieves N+K words of secure data corresponding to the data access request. The N+K words of secure data are converted into N words of data using the data security key. The N words of data are then transmitted to the requesting data consumer. Throughout this process, the requesting data consumer is unaware that the N words of data are stored as N+K words within the canister. The requesting data consumer may be the same system or a system different from the data producer.

In other embodiments of the present invention, security operations performed on received data include data encryption, authentication, and the like.

A method of operating a data storage canister is also provided. Data having a set data size is received for storage within the canister. At least one data security operation is performed on the received data to generate secure data having a secure data size different than the set data size. The secure data is stored on at least one data storage device within the canister. Any information about the secure data size is hid from the data producer.

A data storage canister is also provided. The canister includes data storage devices and a controller. The controller performs at least one security operation on data received by the canister for storage on the plurality of data storage devices. The received data, received from a producer data system, has a received data size. The security operation generates secure data having a secure data size different than the received data size. The controller hides information about the secure data size from the producer data system and hides information about the received data size from the data storage devices.

The above features, and other features and advantages of the present invention are readily apparent from the following detailed descriptions thereof when taken in connection with the accompanying drawings.

### BRIEF DESCRIPTION OF THE DRAWINGS

FIG. 1 is a schematic diagram illustrating a data storage canister that may include the present invention;

FIG. 2 is a block diagram illustrating a data storage canister controller according to an embodiment of the present invention;

FIG. 3 is a block diagram illustrating another data storage canister controller according to an embodiment of the present invention;

FIG. 4 is a block diagram illustrating yet another data storage canister controller according to an embodiment of the present invention;

FIG. 5 is a block diagram illustrating a data storage system according to an embodiment of the present invention;

FIG. 6 is a flow diagram illustrating data encryption according to an embodiment of the present invention; and

FIG. 7 is a flow diagram illustrating data authentication according to an embodiment of the present invention.

### DETAILED DESCRIPTION OF THE PREFERRED EMBODIMENT(S)

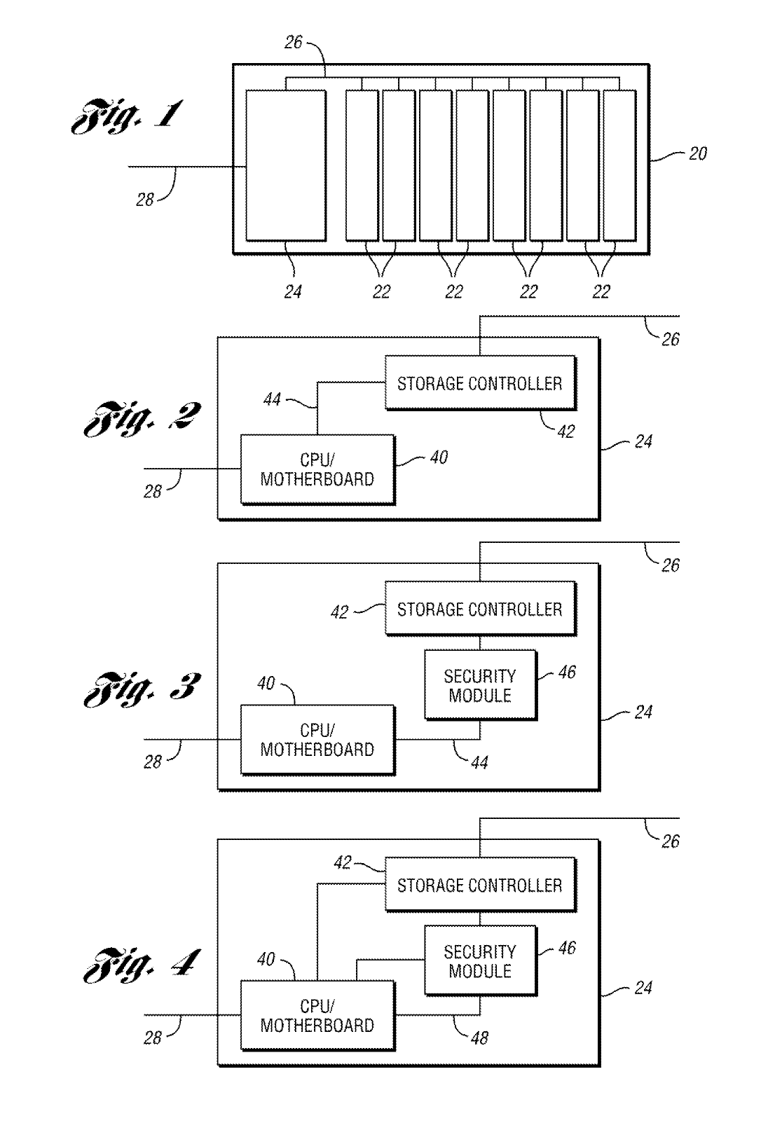

Referring to FIG. 1, a schematic diagram illustrating a data storage canister that may include the present invention is shown. Data storage canister 20 includes a plurality of data storage devices 22. Data storage devices are preferably low-cost commodity magnetic disk drives such as, for example, ATA hard disk drives. However, the present invention applies to data storage canister 20 holding a wide variety of data storage devices 22 including high-end hard disk drives, optical drives disk drives, and the like.

Data storage canister 20 also includes one or more controllers, referenced as controller 24, controlling and interfacing data storage devices 22. Controller 24 interconnects with storage devices 22 through internal path 26 which may be one or more of a parallel bus, serial bus or wireless link. Controller 24 receives data from, and transmits data to, devices outside of canister 20 over link 28. Link 28 may be any one or more data communication medium and/or standard including Fibre Channel, SCSI, Ethernet, iSCSI, TCP/IP, cable, fiber, wireless connection, or the like. Controller 24 typically performs a wide variety of functions including protocol conversion, data formatting, data compaction, error correction and detection, and control of data storage devices 22.

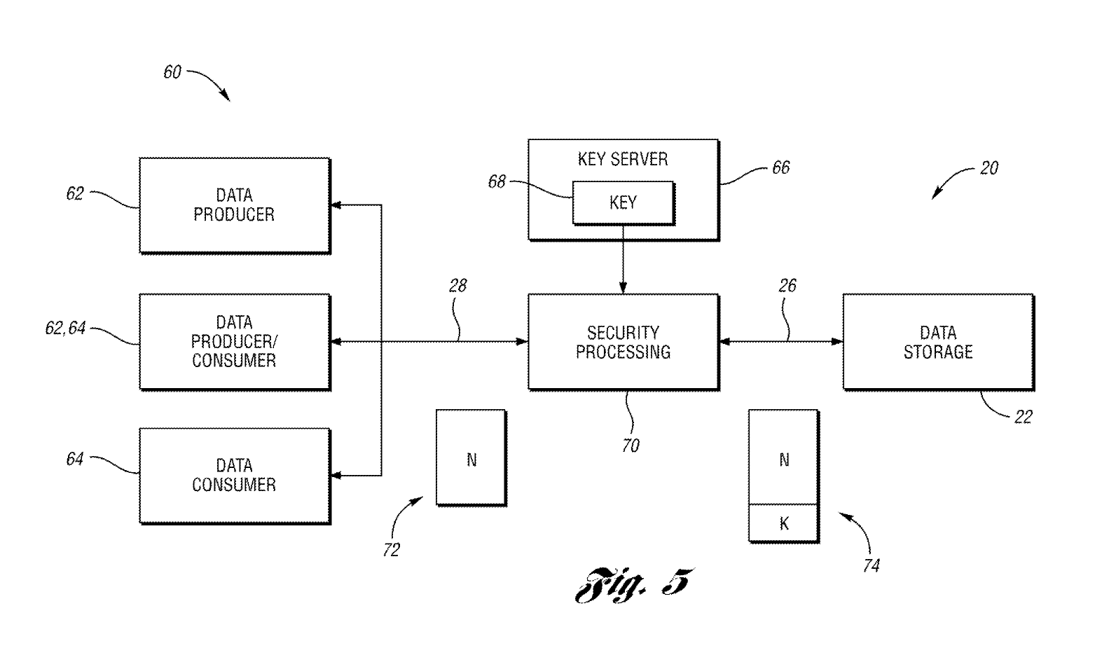

Referring now to FIG. 2, a block diagram illustrating a data storage canister controller according to an embodiment of the present invention is shown. Controller 24 typically includes processor 40 and one or more storage controllers, referenced as storage controller 42, interconnected by bus 44. Processor 40 handles interface with producers or consumers of data connected through link 28. Processor 40 also handles data formatting, protocol conversion, data compaction, and the like. Processor 40 may also handle decisions regarding how data is to be stored amongst data storage devices 22. Storage controller 42 passes data to data storage devices 22 over internal path 26. Storage controller 42 is also responsible for monitoring the operation of data storage devices 22. In this embodiment security operations, described in detail below, are implemented by software executing on processor 40.

Referring now to FIG. 3, a block diagram illustrating another data storage canister controller according to an embodiment of the present invention is shown. In this embodiment, security module 46 is inserted in bus 44 between processor 40 and storage controller 42. Security module 46 performs security operations such as encryption/decryption and authentication on data which passes between processor 40 and storage controller 42. Security module 46 may be implemented as software running on a microprocessor, as logic in a custom integrated circuit, as discrete logic, or any combination thereof.

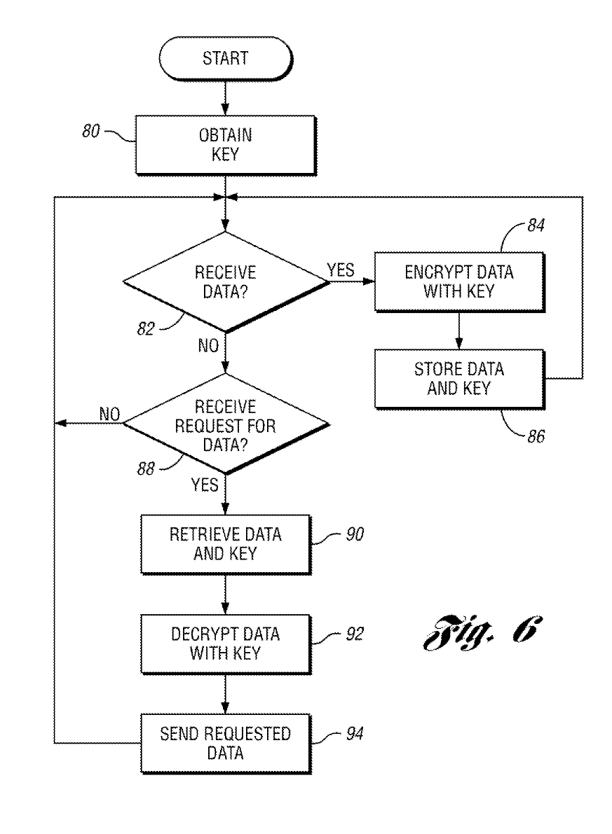

Referring now to FIG. 4, a block diagram illustrating yet another data storage canister controller according to an embodiment of the present invention is shown. In this embodiment, security module 46 connects to processor 40 via a separate bus 48. Processor 40 routes received data to security module 48 and receives secure data back from security module 48. Processor 40 then sends the secure data over bus 44 to storage controller 42 for storing in canister 20. When responding to a request for data, processor 40 instructs storage controller 42 to retrieve secure data. Processor 40 then routes the secure data to security module 46 prior to sending the processed data out over link 28.

Referring now to FIG. 5, a block diagram illustrating a data storage system according to an embodiment of the present invention is shown. A data storage system, shown generally by 60, includes data producers 62 and data consumers 64 capable of accessing canister 20 over link 28. In this context, data producers generate data for storage in data storage canister 20. Data consumers retrieve data held in canister 20. Data producers 62 may be the same or separate systems from data consumers 64. Either or both of data producers 62 and data consumers 64 may be server computer systems, client computer systems, host computers, personal computers, workstations, communication systems, and the like. Producers 62 and consumers 64 may be directly connected to canister 20 or may be indirectly connected through one or more data networks.

Data storage system 60 also includes one or more key servers, referenced as key server 66, generating one or more security keys 68. Key 68 may be used in one or more cryptographic processes such as encryption, decryption, authentication, and the like. Management of key 68 may be handled locally, within canister 20, or in a location accessible to canister 20 such as a key management station implementing key server 66.

Local key management may be implemented by inserting a smart card into a smart card reader added as an additional modules within the canister 20 and accessible as a logical component of controller 24. This method incorporates a key designation variable that is stored with each data block or in a global table on each data storage device 22.

A network-based key management station may be used to avoid adding extra components to canister 20. In this embodiment, as a data write request is received by controller 24, the key designation variable is retrieved from the key management station and is stored with the data block. When a data read request is received by controller 24, the key designation variable is retrieved from data storage device 22 as the data block is read. It is then securely sent to the key management station, which returns cryptographic key 68.

Security processing 70, implemented within canister 20, implements one or more security operations such as encryption, decryption, authentication, and the like, using one or more well-known security algorithms During a data storage operation, canister 20 receives data set 72 having a fixed size, indicated by N, that may be measured in records, bytes, bits, or the like, which can be generally referred to as words. Security processing 70 operates on data set 72 to produce secure data 74. Secure data set 74 contains a greater number of words than data set 72, shown here as N+K, as a result of security processing. When data is retrieved from canister 20 a reverse process occurs. Secure data 74 is converted to data set 72 of smaller size prior to transmission over link 28. The present invention hides details of security processing from data producers 62 and data consumers 64. These details include the size of secure data 74 stored on one or more data storage devices 22.

One possible type of security processing 70 is data encryption/decryption. Data encryption secures the contents of canister 20 from unwanted viewers using any well known cryptographic mechanism. The general operation for data encryption within canister 20 can be totally transparent to data producer 62 and/or data consumer 64 since it occurs within canister 20. In one embodiment, cryptographic key 68 is obtained by and used within controller 24. As data set 72 flows into canister 20, it is encrypted by security processing 70 executing in controller 24. Once encrypted, secure data 74 is sent to particular data storage devices 22 incorporated within canister 20. As data is requested from canister 20, security processing 70 decrypts secure data 74 into data set 72 and passes data set 72 out link 28 to requesting data consumer 64.

In an embodiment of the present invention, a key designation variable is created with each logical unit of storage, such as block, sector, and the like, and is stored with the data. The key designation variable may be stored either with the actual data block or in a global table on one or more storage device 22.

Another type of security processing is data authentication. Data authentication includes a variety of algorithms In one type, for example, authentication verifies that a particular piece of data was written at a certain time and has not been modified. In essence, this implements a logical Write Once Read Many (WORM).

Preferably, the general operation for data authentication within canister 20 is essentially transparent to the user since it occurs within canister 20. For example, cryptographic key 68 is obtained by and used within controller 24. As data set 72 flows into canister 20 via link 28, a digital signature, such as a cryptographic hash of the data, is created by controller 24. With each logical unit of storage, such as data block, sector, or the like, a digital signature is created and stored with the data as secure data 74. The digital signature may be stored either with the actual data block or in a global table on one or more storage devices 22. This signature may be used to check the data before producing data set 72 to requesting data consumer 64.

Key designation variables and, if necessary, other cryptographic reference information, can stored directly with the data block. Security processing 70 intercepts read/write and block size request/modification commands. For example, a data write request is received by controller 24 specifying a block size such as, for example, 32 Kbytes. Security processing intercepts the request and resets the block size request to be 32 Kbytes plus some additional space for the key designation variable. The additional size can be of almost any length as necessary, and is preferably a predefined constant value such as, for example, 108 bytes. The modified data write request having the data with the new block size is then passed along to a receiving data write process, such as implemented in storage controller 42.

The process requesting data storage in data producer 62 thinks that it has successfully requesting 32 Kbytes. The one or more data storage devices 22 believe that 32 Kbytes+108 bytes have been requested. Both sides of this process are fooled while security processing 70 handles the size conversion. The equal but opposite process is conducted for data read requests received from data consumer 64.

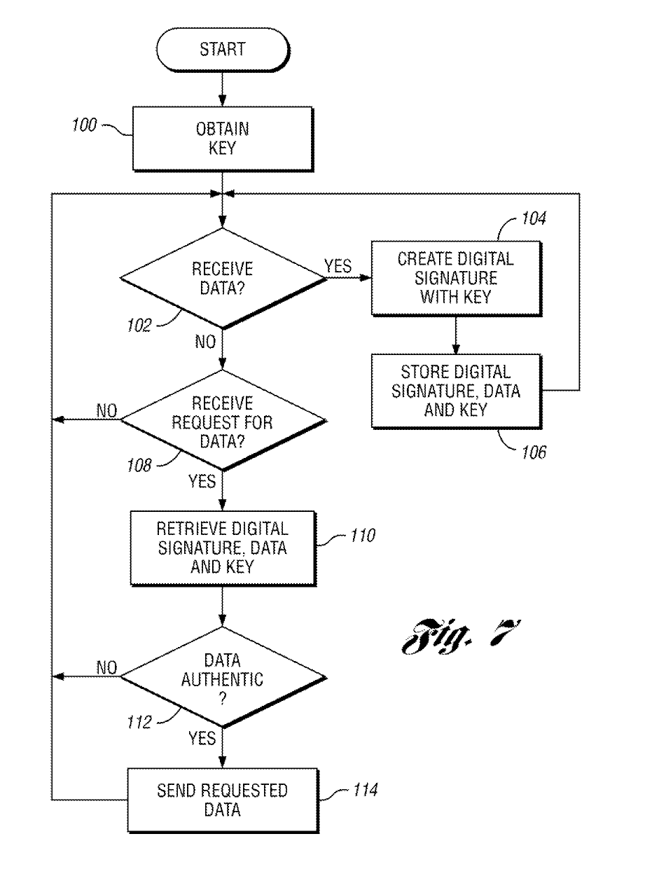

Referring now to FIGS. 6 and 7, flow diagrams illustrating security operations according to embodiments of the present invention are shown. As will be appreciated by one of ordinary skill in the art, the operations illustrated are not necessarily sequential operations. The order of steps may be modified within the spirit and scope of the present invention and the order shown here is for logical presentation. Also, methods illustrated may be implemented by any combination of hardware, software, firmware, and the like, at one location or distributed. The present invention transcends any particular implementation and the embodiments are shown in sequential flow chart form for ease of illustration. In addition, while example embodiments for encryption/decryption are provided, the present invention applies to any security processing by canister 20.

With particular reference to FIG. 6, a flow diagram illustrating data encryption according to an embodiment of the present invention is shown. A key is obtained, as in block 80. Key 68 may be obtained before receiving a request to store data, before the data itself is received or after receiving data. A unique key 68 may be obtained for each controller 24, each data access request, each data set, 72 or for individual blocks or sectors of data within data set 72.

A check is made to determine if data is received, as in block 82. If data is received from data producer 62, the data is encrypted with key 68 to create secure data 74, as in block 84. The data and additional information are stored onto one or more storage devices 24 in canister 20, as in block 86. This additional information may be the key, a key designation variable, or the like. Data producer 62 is unaware of the amount of space required to store secure data 74.

A check is made to determine if a request for data is received, as in block 88. If so, secure data 74 including encrypted data are retrieved, as in block 90. This data may include the key designation variable and/or the key. The data is decrypted using key 68, as in block 92. The data is then sent to requesting data consumer 64, as in block 94. Requesting data consumer 64 is unaware of the amount of space required to store secure data 74.

Referring now to FIG. 7, a flow diagram illustrating data authentication according to an embodiment of the present invention is shown. Key 68 is obtained, as in block 100. As with encryption, authentication key 68 may be obtained before receiving a request to store data, before the data itself is received or after receiving data. A unique key 68 may be obtained for each controller 24, each data access request, each data set, 72 or for individual blocks or sectors of data within data set 72.

A check is made to determine if data was received, as in block 102. If so, a digital signature for data set 72 is created with key 68, as in block 104. Secure data 74 including the digital signature, data and key 68 are stored in at least one data storage device 22, as in block 106. Data producer 62 sending data set 72 need be unaware of the amount of storage actually required to hold secure data 74.

A check is made to determine if a request for data is received, as in block 108. If so, secure data 74 corresponding to the request and including key 68 and the digital signature are retrieved, as in block 110. A check is made to determine if the data is authentic, as in block 112. This check may include generating a second digital signature using the retrieved data and key 68 and comparing the second digital signature with the retrieved digital signature. If the data is authenticated, data set 72 is sent to requesting data consumer 64, as in block 114. Requesting data consumer 64 need be unaware of the amount of storage actually required to hold secure data 74.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A data storage system comprising:
at least one data producer generating data for storage;
a key server providing a data security key; and
at least one data storage canister, each data storage canister comprising a plurality of data storage devices and a controller, the controller in communication with the plurality of data storage devices, the at least one data producer and the key server, the controller operative to
(a) receive data for storage within the canister, the data having a size of N words,
(b) receive the data security key from the key server,
(c) perform at least one data security operation on the received data with the received data security key to generate secure data, the secure data having a size of N+K words, and
(d) store the N+K words on at least one of the plurality of data storage devices;
whereby the at least one data producer is unaware that the N words of data are stored as N+K words within the canister.

2. The data storage system of claim 1 further comprising at least one data consumer generating data access requests for the at least one data storage canister, the controller further operative to
(e) receive a data access request from a requesting data consumer to access N words of data,
(f) retrieve N+K words of secure data corresponding to the data access request,
(g) convert the N+K words of secure data into N words of data using the data security key, and
(h) transmit the N words of data to the requesting data consumer;
whereby the requesting data consumer is unaware that the N words of data are stored as N+K words within the canister.

3. The data storage system of claim 2 wherein the data producer and the data consumer are the same system.

4. The data storage system of claim 2 wherein the data producer and the data consumer are different systems.

5. The data storage system of claim 1 wherein the at least one data security operation comprises data encryption.

6. The data storage system of claim 1 wherein the at least one data security operation comprises data authentication.

7. A method of operating a data storage canister, the data storage canister including a plurality of data storage devices and a controller through which access to the data storage devices is provided, the method comprising:
receiving data for storage within the canister, the data having a set data size, the data received from a data producer;
performing at least one data security operation on the received data with a data security key to generate secure data, the secure data having a secure data size different than the set data size;
storing the secure data on at least one of the plurality of data storage devices; and
hiding any information about the secure data size from the data producer.

8. The method of operating a data storage canister as in claim 7 further comprising:
receiving a data access request from a requesting data consumer to access data held within the canister;
retrieving an amount of secure data from the at least one of the plurality of data storage devices in response to the data access request, the retrieved data having the secure data size;
converting the secure data into non-secure data having the set data size of less than the secure data size;
transmitting the requested data to the requesting data consumer; and
hiding any information about the secure data size from the requesting data consumer.

9. The method of operating a data storage canister as in claim 8 wherein the data producer and the requesting data consumer are the same system.

10. The method of operating a data storage canister as in claim 8 wherein the data producer and the requesting data consumer are different systems.

11. The method of operating a data storage canister as in claim 7 wherein the at least one data security operation comprises data encryption.

12. The method of operating a data storage canister as in claim 7 wherein the at least one data security operation comprises data authentication.

13. A data storage canister comprising:
a plurality of data storage devices disposed within the data storage canister; and
a controller disposed within the data storage canister, the controller in communication with the plurality of data storage devices and a data producer outside the data storage canister, the controller performing at least one security operation on data received by the canister for storage on the plurality of data storage devices, the received data is received from the producer data system having a received data size, the at least one security operation generating secure data having a secure data size different than the received data size, the controller hiding information about the secure data size from the producer data system and hiding information about the received data size from the plurality of data storage devices.

14. The data storage canister of claim 13 wherein the controller receives a request to access the received data from a requesting data consumer, the controller converting the secure data into the received data, the controller hiding information about the secure data size from the requesting data consumer.

15. The method of operating a data storage canister as in claim 14 wherein the data producer and the requesting data consumer are the same system.

16. The method of operating a data storage canister as in claim 14 wherein the data producer and the requesting data consumer are different systems.

17. The method of operating a data storage canister as in claim 13 wherein the at least one security operation comprises data encryption.

18. The method of operating a data storage canister as in claim 13 wherein the at least one security operation comprises data authentication.
